(19) United States
(12) Patent Application Publication
(10) Pub. No.: US 2015/0321288 A1
(43) Pub. Date: Nov. 12, 2015

(54) METHOD OF LASER CLADDING A METALLIC COAT ON A METAL ELEMENT

(71) Applicant: PLASMA SYSTEM S.A., Siemianowice Slaskie (PL)

(72) Inventor: Aleksander BOREK, Katowice (PL)

(73) Assignee: PLASMA SYSTEM S.A., Siemianowice Slaskie (PL)

(21) Appl. No.: 14/652,598

(22) PCT Filed: Dec. 19, 2013
(86) PCT No.: PCT/PL2013/000169

§ 371 Date: Jun. 16, 2015

(30) Foreign Application Priority Data
Dec. 19, 2012 (PL) P.402131

(51) Int. Cl. B23K 26/34; C21D 9/46; C22C 38/58; C22C 38/56; C22C 38/54; B23K 26/30; C22C 38/50; C22C 38/46; C22C 38/44; C22C 38/42; C22C 38/34; C22C 38/00; C21D 1/09; C22C 38/52

(52) U.S. Cl. CPC B23K 26/34; C21D 1/09; C21D 9/46; C22C 38/58; C22C 38/56; C22C 38/54; C22C 38/52; C22C 38/50; C22C 38/46; C22C 38/44; C22C 38/42; C22C 38/34; C22C 38/005; C22C 38/002; B23K 26/421

(57) ABSTRACT

The present invention refers to a method of laser cladding of a metallic coat on a metal element. The method consists in hardening the metal surface, favorably by laser, and then laser cladding of at least one layer of metallic material.

The present invention refers to a method of cladding a metallic coat on a metal element in order to obtain optimum substrate parameters.

There is known from the Polish patent PL 207497 a method of laser cladding with adjustment of the chemical composition of the cladding layer, where the melt pool receives simultaneously an additional material in the form of a solid or powder wire, and an additional material in the form of metallic powder, ceramic powder or cermet powder, where the chemical composition of the clad layer, and therefore its chemical properties are adjusted by proper control of energy in a linear laser beam of a power of 0.8 kW-2.2 kW, wire feeding speed of 0.2 m/min-1.2 m/min and powder feeding intensity of 1.0 g/min-15.0 g/min.

Methods of laser cladding a metallic layer on metal elements known in the art lead to negative hardening of substrate material in the area of laser application of a metallic coat, and a thickness of this unfavorably hardened metal substrate may reach 3.0 mm.

Significant increase in hardness and other mechanical parameters can lead to scaling of the substrate material in the metallic layer application area once an element has to carry mechanical loads.

A method according to the invention consists in hardening of the surface of a metal element, favorably by laser, and then in laser cladding of at least one layer of a metallic material.

In a method according to the invention, the surface of a metal element after hardening is cleaned mechanically and/or chemically to remove oxides, and then the surface of a metal element is hardened, favorably by laser, and oxides are removed from it, and then at least one layer of metallic material is clad of a thickness of 0.3 mm to 4.0 mm, favorably from 1.0 mm to 2.0 mm, said material containing the following in addition to iron: carbon in the amount of 0.05% by weight to 3.60% by weight, manganese in the amount of 0.10% by weight to 2.50% by weight, chromium in the amount of 0.50% by weight to 30.00% by weight, nickel in the amount of 0.50% by weight to 51.00% by weight, titanium in the amount of 0.05% by weight to 5.50% by weight, silicon in the amount of 0.30% by weight to 2.40% by weight, molybdenum in the amount of 0.04% by weight to 4.50% by weight, wolfram in the amount of 0.90% by weight to 4.50% by weight, cobalt in the amount of 1.50% by weight to 10.00% by weight, vanadium in the amount of 0.20% by weight to 4.00% by weight, phosphorous in the amount of 0.15% by weight, sulfur in the amount of up to 0.04% by weight, copper in the amount of 0.10% by weight to 1.20% by weight, magnesium in the amount of 0.03% by weight to 0.07% by weight, yttrium in the amount of 0.001% by weight to 0.005% by weight, boron in the amount of 0.002% by weight to 0.006% by weight, tellurium in the amount of 0.0005% by weight to 0.002% by weight, strontium in the amount of 0.002% by weight to 0.006% by weight, cerium in the amount of 0.003% by weight to 0.006% by weight.

In a favorable embodiment the surface of a metal element is hardened, favorably by laser, and then oxides are removed and at least one layer of metallic material is clad, favorably an aluminum bronze and/or manganese bronze and/or beryllium bronze layer of a thickness of 0.2 mm to 4.0 mm, favorably from 0.8 mm to 1.5 mm.

An advantage of the method according to the invention consists in deliberate tempering of the previously hardened metal substrate by the heat provided while cladding at least one metallic layer. Optimum original mechanical parameters of metal are obtained under the clad metallic layer.

### Example 1

The surface of a roll used in steelmaking industry was hardened by a 2000 W laser with a ˜4.3 mm spot, said roll made of carbon steel having carbon content of around 0.4% by weight, and then, after oxides formed in the process of hardening were removed, a layer of around 1.5 mm was laser-clad, with a cladding layer having the following chemical composition: nickel of around 70.9% by weight, chromium of around 16.9% by weight, iron of around 4.0% by weight, silicon of around 4.1% by weight, boron of around 3.4% by weight and carbon of around 0.81% by weight Heat provided in the process of cladding tempered a pre-hardened layer of a thickness of around 300 HB.

### Example 2

The surface of the rim of a wheel used in rail transport and having contact with a rail head was hardened by a 2000 W laser beam of a ˜4.3 mm spot, and then, after oxides formed in the hardening process were removed, a laser cladding procedure was applied using a ˜3000 M laser, of a path width of around 4.0 mm, to apply a metallic layer of a thickness of around 0.8 mm. The heat provided in the cladding process tempered a pre-hardened layer to an optimum hardness of around 260 HB.

1. A method of laser welding of a metallic coat on a metal element characterized in that the surface of a metal element is hardened, favorably by laser, and then clad by a laser with at least one layer of metallic material.

2. A method according to claim 1 characterized in that oxides are mechanically and/or chemically removed from the surface of a metal element after hardening.

3. A method according to claim 1 characterized in that the surface of a metal element is hardened, favorably by laser, and the oxides are removed from it, and at least one layer of metallic material of a thickness of 0.3 mm to 4.0 mm, favorably from 1.0 mm to 2.0 mm is clad, which, favorably in addition to iron contains the following: carbon in the amount of 0.05% by weight to 3.60% by weight, manganese in the amount of 0.10% by weight to 2.50% by weight, chromium in the amount of 0.50% by weight to 30.00% by weight, nickel in the amount of 0.50% by weight to 51.00% by weight, titanium in the amount of 0.05% by weight to 5.50% by weight, silicon in the amount of 0.30% by weight to 2.40% by weight, molybdenum in the amount of 0.04% by weight to 4.50% by weight, wolfram in the amount of 0.90% by weight to 4.50% by weight, cobalt in the amount of 1.50% by weight to 10.00% by weight, vanadium in the amount of 0.20% by weight to 4.00% by weight, phosphorous in the amount of 0.15% by weight, sulfur in the amount of up to 0.04% by weight, copper in the amount of 0.10% by weight to 1.20% by weight, magnesium in the amount of 0.03% by weight to 0.07% by weight, yttrium in the amount of 0.001% by weight to 0.005% by weight, boron in the amount of 0.002% by weight to 0.006% by weight, tellurium in the amount of 0.0005% by weight to 0.002% by weight, strontium in the amount of 0.002% by weight to 0.006% by weight, cerium in the amount of 0.003% by weight to 0.006% by weight.

4. A method according to claim 1 characterized in that the surface of a metal element is hardened, favorably by laser, and then oxides are removed and at least one layer of metallic material is clad, favorably an aluminum bronze and/or manganese bronze and/or beryllium bronze layer of a thickness of 0.2 mm to 4.0 mm, favorably from 0.8 mm to 1.5 mm.
